(19) United States
(12) Patent Application Publication
(10) Pub. No.: US 2010/0329932 A1
(43) Pub. Date: Dec. 30, 2010

(54) Sensing device

(75) Inventors: Tomoya Yorita, Sayama-shi (JP); Shunichi Wakamatsu, Sayama-shi (JP); Shigenori Watanabe, Sayama-shi (JP); Takeru Mutoh, Sayama-shi (JP)

Correspondence Address: JORDAN AND HAMBURG LLP, 122 EAST 42ND STREET, SUITE 4000, NEW YORK, NY, 10168, US

(73) Assignee: NIHON DEMPA KOGYO CO., LTD., Shibuya-ku (JP)

(21) Appl. No.: 12/803,220

(22) Filed: Jun. 22, 2010

(30) Foreign Application Priority Data
Jun. 24, 2009 (JP) 2009-150308

(51) Int. Cl. G01N 27/00

(52) U.S. Cl. 422/82.01

(57) ABSTRACT

To provide a sensing device that measures a substance to be sensed while letting a sample solution flow and has improved accuracy in detecting the substance to be sensed. The sensing device includes: a channel forming member 50 including an opposed surface opposed to an oscillation area on one surface side of a piezoelectric sensor via a gap to form a reaction channel in an area facing the one surface side; a liquid supply channel through which a liquid is supplied to the reaction channel and a liquid discharge channel through which a liquid is discharged from the reaction channel; oscillator circuits 30a, 30b oscillating the quartz-crystal piece; and a frequency measuring part 81 measuring oscillation frequencies of the oscillator circuits 30a, 30b, wherein a height of the reaction channel facing the oscillation area on the one surface side of the quartz-crystal sensor is 0.2 mm or less.

### BACKGROUND OF THE INVENTION

1. Field of the Invention

The present invention relates to a sensing device for sensing a substance to be sensed contained in a sample solution based on a natural frequency of a piezoelectric resonator such as a quartz-crystal resonator.

2. Description of the Related Art

As a sensing device sensing and measuring a trace amount of a substance contained in a sample solution, there has been known one using a quartz-crystal sensor utilizing a quartz-crystal resonator. In the quartz-crystal sensor, an adsorption layer made of a biological substance film or the like that reacts with a specific substance to be sensed is formed on a front surface of a metal electrode (excitation electrode) provided on a quartz-crystal piece. According to a mass change of the adsorption layer when it reacts with the substance to be sensed present in a sample solution to adsorb the substance to be sensed, a natural frequency of the quartz-crystal resonator changes, and the concentration of the substance to be sensed is measured based on this action.

As the sensing device, there has been known a flow-through type that measures a substance to be sensed while letting a sample solution flow, as disclosed in, for example, a patent document 1. The sensing device of the flow-through type includes a quartz-crystal sensor, an oscillator circuit for oscillating a quartz-crystal piece, and a frequency measuring part measuring an oscillation frequency. As shown in FIG. 10, in the quartz-crystal sensor, a quartz-crystal resonator 10 is placed on a wiring board 11 so as to close a hole portion 11a, and the quartz-crystal resonator 10 is pressed by a quartz-crystal pressing member 12. Further, since the hole portion 11a is closed by a sealing member 13 from under, a rear surface side of the quartz-crystal resonator 10 is exposed to an airtight atmosphere.

In the sensing device, a reaction channel 15 is formed so as to surround an area facing a front surface of the quartz-crystal resonator 10 of the quartz-crystal sensor when the quartz-crystal sensor is mounted on a bottom portion of a case 14. A liquid supply channel 14a and a liquid discharge channel 14b are connected to both sides of the reaction channel 15, a sample solution flows from the liquid supply channel 14a to the liquid discharge channel 14b via the reaction channel 15, and at this time, a substance to be sensed in the sample solution is adsorbed by an adsorption layer of the quartz-crystal resonator 10. A buffer solution is supplied to the reaction channel 15 before the sample solution is supplied thereto, and based on a change between the frequencies of the quartz-crystal resonator 10 measured at these times, the concentration of the substance to be sensed in the sample solution is estimated.

In a clinical field and an environment field, such a sensing device is required to measure a trace amount of a substance to be sensed with as high sensitivity and accuracy as possible, and to meet this requirement, various studies have been made regarding the quartz-crystal resonator 10, a measuring system, and a structure part. With the above background, the present inventor focused attention on the height of the aforesaid reaction channel 15 (distance H from the front surface of the quartz-crystal resonator 10 to an opposed surface in the case 14). That is, the height H of the reaction channel 15 developed by the present inventor is set to, for example, 1.00 mm in order to realize quick measurement of the substance to be sensed.

In a case where the substance to be sensed is, for example, an antigen, while the sample solution flows in layers in the reaction channel 15, the antigen in the flowing liquid at a place distant from the quartz-crystal resonator 10 is also attracted by an antibody of the quartz-crystal resonator 10, but the larger the distance from the quartz-crystal resonator 10 is, the lower a degree of the attraction is. Therefore, even if the height of the reaction channel 15 is as small as 1 mm, a ratio of an amount of the antigen in the flowing liquid reacting with the antibody is smaller on the opposed surface side than that on the quartz-crystal resonator 10 side. Therefore, when the height H of the reaction channel 15 is 1.0 mm, a ratio of an amount of the substance to be sensed adsorbed by the adsorption layer to the total amount of the substance to be sensed contained in the supplied sample solution is low. Therefore, it cannot be said that this is advantageous in view of both sensitivity and accuracy.

[Patent document 1] Japanese Patent Application Laid-open No. 2008-58086 (paragraph [0008], FIG. 11 and FIG. 13)

### SUMMARY OF THE INVENTION

The present invention was made under such circumstances and has an object to provide a sensing device measuring a substance to be sensed while letting a sample solution flow, and capable of sensing the substance to be sensed with high accuracy.

A sensing device of the present invention is a device which uses a piezoelectric sensor having an adsorption layer formed on an electrode provided on a piezoelectric piece, and senses a substance to be sensed in a sample solution based on a change in a natural frequency of the piezoelectric piece caused by the adsorption of the substance to be sensed by the adsorption layer when the sample solution is supplied to the piezoelectric sensor in a flowing manner, the sensing device including:

a channel forming member including an opposed surface opposed to an oscillation area on one surface side of the piezoelectric sensor via a gap to form a reaction channel in an area facing the one surface side;

a liquid supply channel through which a liquid is supplied to the reaction channel and a liquid discharge channel through which a liquid is discharged from the reaction channel;

an oscillator circuit oscillating the piezoelectric piece; and

a frequency measuring part measuring an oscillation frequency of the oscillator circuit, wherein

a height of the reaction channel facing the oscillation area on the one surface side of the piezoelectric sensor is 0.2 mm or less.

The sensing device may take the following structures.

1. The reaction channel includes the opposed surface and an inner peripheral surface surrounding a periphery of an area above the oscillation area,

the liquid supply channel includes: an inner channel whose downstream end is opened in part of the inner peripheral surface and whose upstream end is located on a front surface of the piezoelectric piece outside the reaction channel; and an outer channel through which a liquid flows into the upstream end of the inner channel, and

the liquid discharge channel includes: an inner channel whose upstream end is opened in part of the inner peripheral surface and whose downstream end is located on the front surface of the piezoelectric piece outside the reaction channel; and an outer channel through which a liquid flows out from the downstream end of the inner channel.

2. The piezoelectric sensor includes: the piezoelectric piece attached to one end side of a wiring board; a connection terminal provided on another end side of the wiring board to electrically connect the electrode of the piezoelectric piece to the oscillator circuit; and a conductive path provided on the wiring board to connect the electrode and the connection terminal,

on the piezoelectric piece, two pairs of the electrodes are formed at a spaced interval to respectively form a first oscillation area and a second oscillation area that oscillate independently of each other, and

in order for the conductive path provided for one pair of the electrodes out of two pairs of the electrodes to have an equal impedance to an impedance of the other conductive path provided for the other pair of the electrodes, the conductive path whose portion connected to the electrode is closer to the connection terminal, out of the both conductive paths, is in a meandering shape.

According to the present invention, since the distance between the front surface of the piezoelectric sensor and the opposed surface, that is, the height of the reaction channel is set to 0.2 mm or less, a ratio of a volume of the sample solution coming into contact with or flowing near the adsorption layer of the piezoelectric piece to the total volume of the supplied sampled solution increases. Therefore, the adsorption layer adsorbs a more amount of the substance to be sensed contained in the sample solution, resulting in a less amount of the substance to be sensed discharged without being adsorbed. As a result, sensitivity and accuracy of the measurement of the substance to be sensed are improved.

Further, a liquid supplied into the piezoelectric sensor flows in the outer channel and the inner channel on the supply side in this order, reaches the reaction channel, and flows out of the piezoelectric sensor via the inner channel and the outer channel on the discharge side. Therefore, since a place where the liquid reaches the piezoelectric piece from an upper side (supply point) and a place where the liquid flows out from the piezoelectric piece to the upper side (discharge point) are far from the adsorption layer, it is possible to reduce an influence that a change in liquid pressure at the supply point and the discharge point has on liquid flow at a place where the adsorption layer is formed, so that the liquid flow in the oscillation area is stabilized. This enables stable measurement of the substance to be sensed by the sensing device, resulting in high reliability.

### BRIEF DESCRIPTION OF THE DRAWINGS

FIG. 1 is an exploded perspective view showing a sensor unit including a piezoelectric sensor according to the present invention;

FIG. 2 is a vertical sectional view showing the sensor unit;

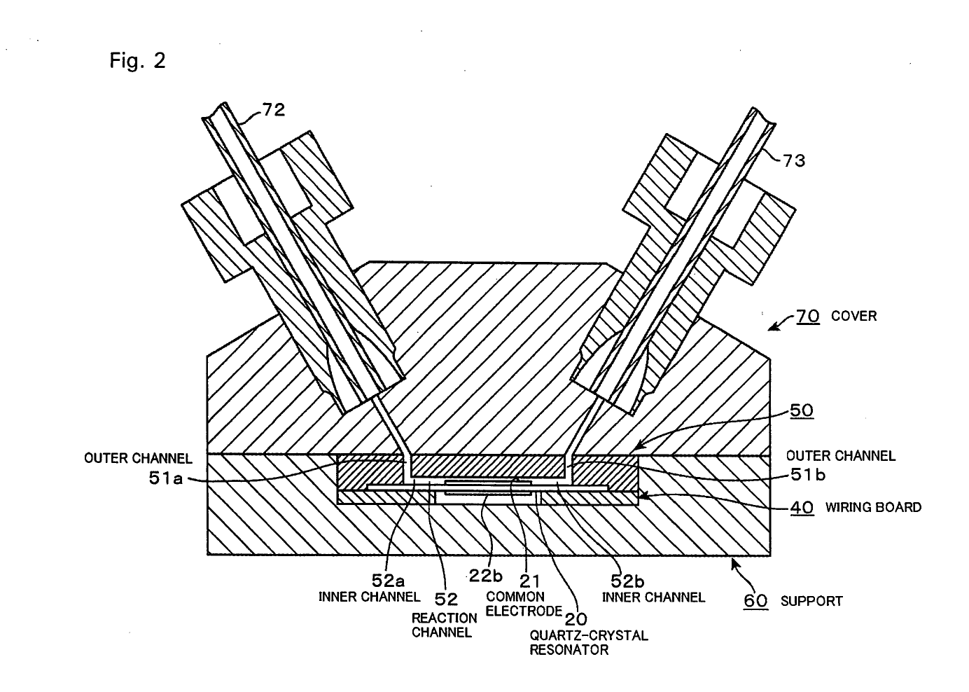

FIG. 3 is an enlarged vertical sectional view showing the sensor unit;

FIG. 4 is a perspective view showing a rear surface of a channel forming member constituting part of the sensor unit;

FIG. 5(a) and FIG. 5(b) are a front view and a rear view showing a quartz-crystal resonator constituting part of the piezoelectric sensor;

FIG. 6 is a top view of a wiring board constituting part of the sensor unit;

FIG. 7 is a layout of oscillator circuits oscillating the quartz-crystal resonator;

FIG. 8 is a block diagram showing the whole structure of a sensing device in which the sensor unit is assembled;

FIG. 9 is an explanatory block diagram showing the connection of the quartz-crystal resonator, a measurement circuit part, and a data processing part which constitute part of the sensing device; and

FIG. 10 is a vertical sectional view showing a conventional piezoelectric sensor.

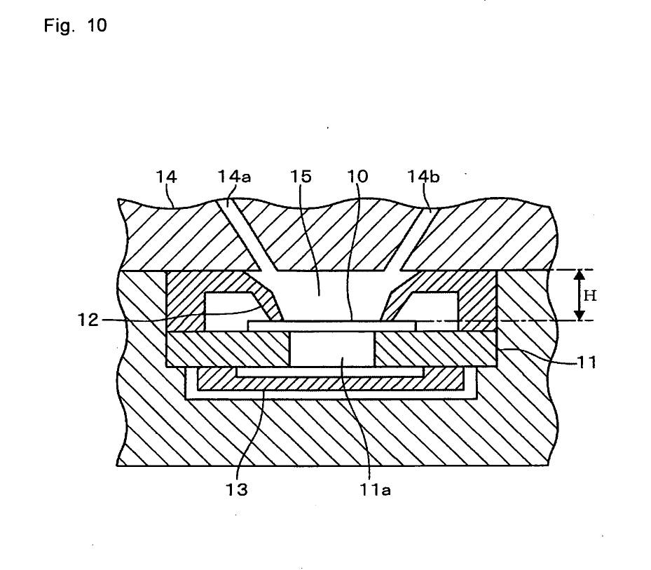

### DETAILED DESCRIPTION OF THE PREFERRED EMBODIMENTS

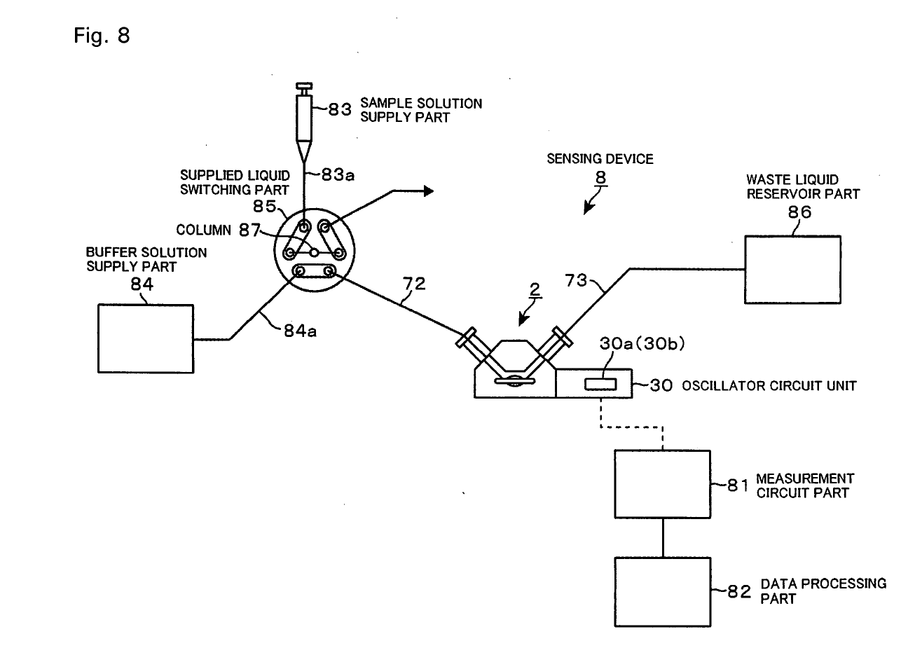

A sensing device 8 according to an embodiment of the present invention includes: a sensor unit 2 in which a piezoelectric sensor 3 is mounted; a supply system supplying a liquid to the sensor unit 2; a discharge system discharging a liquid from the sensor unit 2; an oscillator circuit unit 30; and a measurement circuit part 81, as shown in FIG. 8 which will be described later.

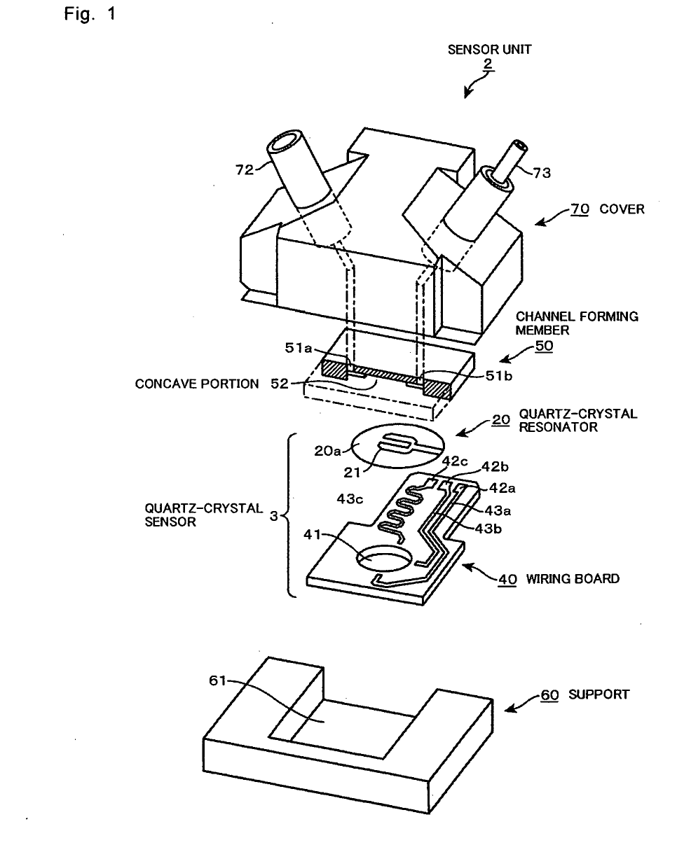

First, a quartz-crystal sensor being the piezoelectric sensor will be described with reference to FIG. 1. The quartz-crystal sensor 3 includes a quartz-crystal resonator 20 being a piezoelectric resonator and a wiring board 40. In the quartz-crystal resonator 20, a common electrode 21 in a U-shape is formed on a front surface of a quartz-crystal piece 20a being a piezoelectric piece in, for example, a circular shape, and on a rear surface of the quartz-crystal piece 20a, an excitation electrode 22a for detection and an excitation electrode 22b for reference are provided at positions opposed to the common electrode 21 so as to be apart from each other. The common electrode 21 is partly led out to an outer edge of the quartz-crystal piece 20a to be led to the rear surface side. This portion led to the rear surface side serves as a portion connected to a later-described conductive path 43b of the wiring board 40 by, for example, a conductive adhesive.

Further, portions of the excitation electrodes 22a, 22b are led out to the outer edge of the quartz-crystal piece 20a and the led-out portions are connected to conductive paths 43c, 43a of the wiring board 40 respectively. The common electrode 21 and the excitation electrodes 22a, 22b each have an equivalent thickness of, for example, 0.2 μm, and as an electrode material, gold, silver, or the like is used, for instance.

In the quartz-crystal piece 20, an area between the common electrode 21 and the excitation electrode 22b forms a first oscillation area, and an area between the common electrode 21 and the excitation electrode 22a forms a second oscillation area. The oscillation of the first oscillation area is caused by the common electrode 21 and the excitation electrode 22b, and the oscillation of the second oscillation area is caused by the common electrode 21 and the excitation electrode 22a.

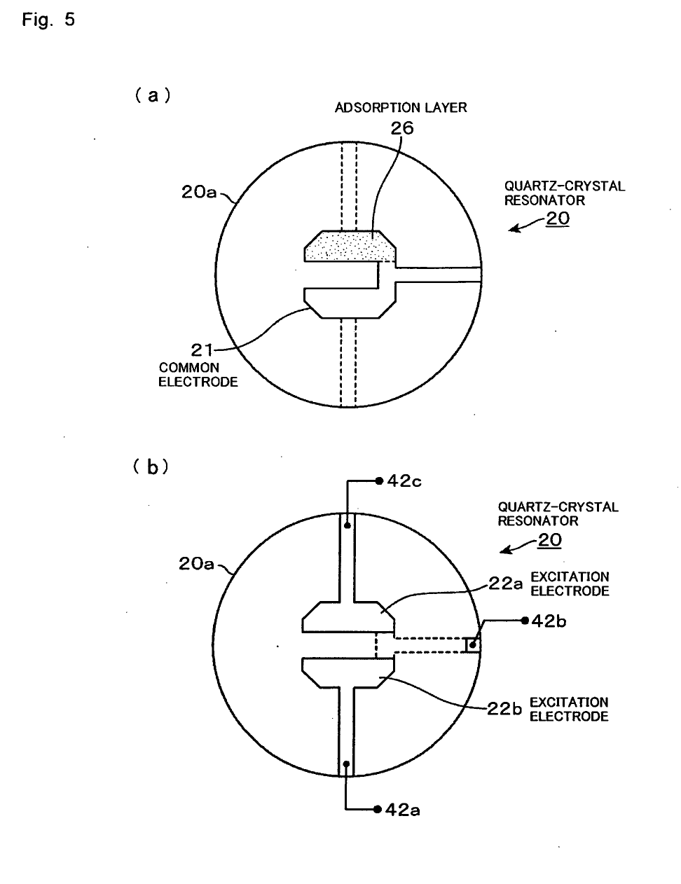

As shown in FIG. 5, on a front surface of the common electrode 21, an adsorption layer 26 is formed in a projection area of the excitation electrode 22a. The adsorption layer 26 is made of, for example, an antibody that adsorbs a substance to be sensed being an antigen and adsorbs the antigen by an antigen-antibody reaction. A mass load effect by the adsorption lowers an oscillation frequency of the second oscillation area. On the other hand, in a projection area of the excitation electrode 22b, the front surface of the common electrode 21 is exposed without the adsorption layer 26 provided thereon, and therefore, an oscillation frequency corresponding to an influence of disturbances such as temperature is taken out from the first oscillation area. Further, in the common electrode 21, the electrode front surface in the area forming the first oscillation area may have thereon a blocking layer made of, for example, a protein, not reacting with the substance to be sensed, for instance, instead of being exposed.

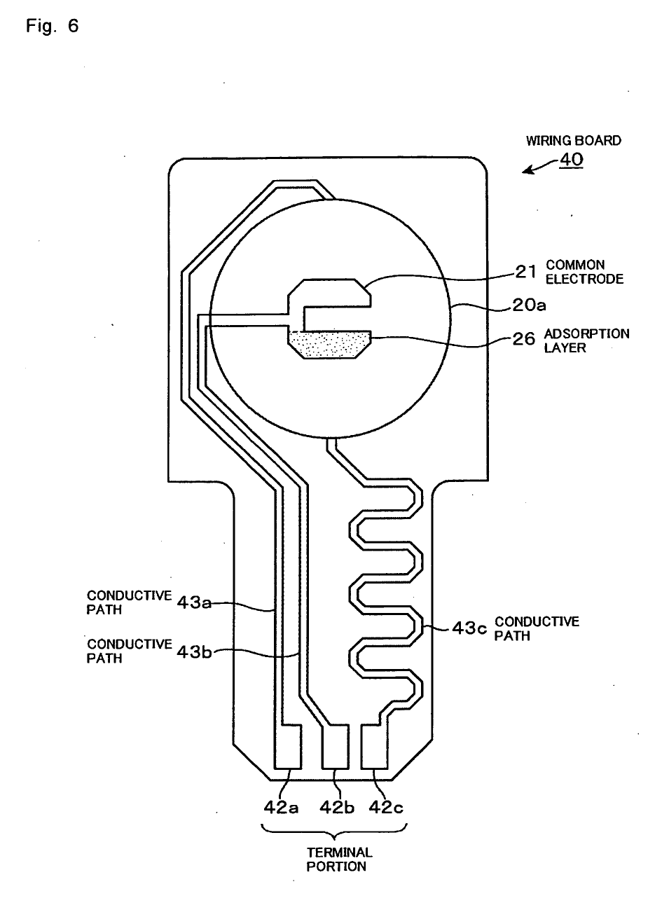

As shown in FIG. 1, the wiring board 40 is constituted by, for example, a printed circuit board, and on its one end side, a through hole 41 for forming a concave portion being an airtight space faced by the rear surface side of the quartz-crystal resonator 20 is formed. Further, as shown in FIG. 1 and FIG. 6, on another end side of the wiring board 40, terminal portions 42a, 42b, 42c for connection to the oscillator circuit 30 are provided. Further, on the wiring board 40, the conductive paths 43a, 43b, 43c are formed to extend from its one end side to other end side, and the conductive paths 43a, 43b, 43c are connected to the terminal portions 42a, 42b, 42c respectively. Therefore, when the quartz-crystal resonator 20 is placed on the wiring board 40 and then the common electrode 21 and the conductive paths are bonded by, for example, a conductive adhesive, the common electrode 21 and the excitation electrodes 22a, 22b are connected to the terminal portions 42b, 42c, 42a via the conductive paths 43b, 43c, 43a respectively.

Here, the conductive paths will be described. In this example, a lead-out position of the electrode 22b in the first excitation area and a lead-out position of the electrode 22a in the second oscillation area are on a straight line extending along a widthwise center portion of the wiring board 40 and are apart from each other by a diameter of the quartz-crystal resonator 20. The lead-out positions are positions where the conductive paths are led out from the quartz-crystal resonator 20. That is, when seen from the terminal portions of the wiring board 40, the former lead-out position is more distant than the latter lead-out position by the diameter of the quartz-crystal resonator 20. Accordingly, the conductive path 43a is longer than the conductive path 43c and has a different impedance from that of the conductive path 43c. Consequently, the first oscillation area and the second oscillation area have different electric characteristics (CI values and so on) when seen from the oscillator circuit unit 30 and have different characteristics regarding short-term stability and long-term stability. Therefore, in this embodiment, the conductive path 43c is formed in a meandering shape so as to become long, so that the conductive paths 43a, 43c are equal in length and thus are equal or substantially equal in impedance.

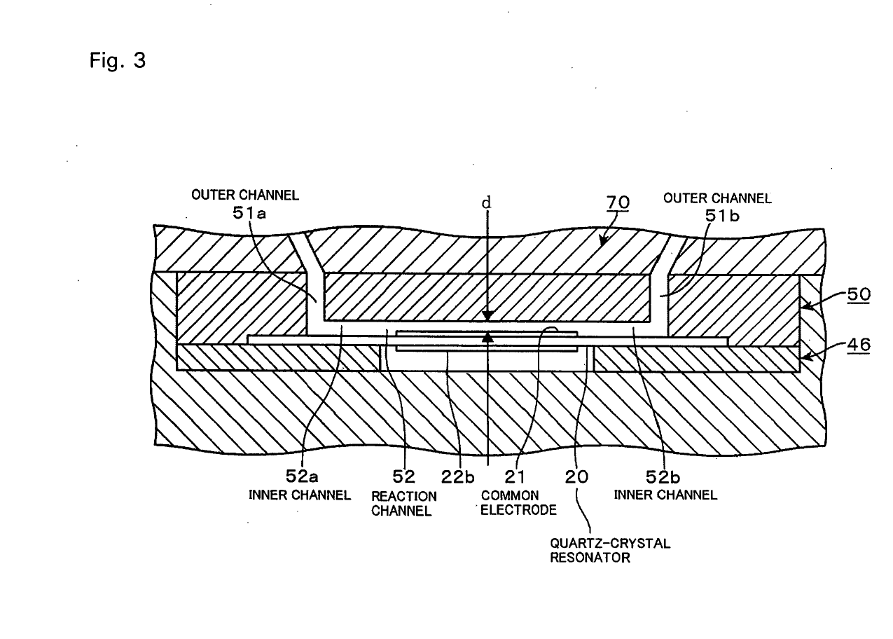

This design is effective especially when the height of the reaction channel 52 is small, specifically, 0.2 mm or less, for example, 0.1 mm. In this case, it is advantageous that a liquid supply point and a liquid discharge point to the outside are located at positions apart from the reaction channel 52 (see FIG. 3) as will be described later. In this structure, in order to prevent liquid leakage, it is desirable that the quartz-crystal piece 20a is located in an area where an inner channel extending from the liquid supply point to the reaction channel 52 is formed and in an area where an inner channel extending from the reaction channel 52 to the liquid discharge point is formed. For this purpose, increasing the size of the quartz-crystal piece 20a is a good way, but this increases a difference between the distances from the two electrode lead-out positions to the terminal portions. In other words, forming one of the conductive paths in a meandering shape in a plane view eliminates a restriction in the setting of the aforesaid lead-out positions and thus frees the layout design of the electrodes from an extra restriction. Therefore, it is possible to avoid a layout that requires special care about the direction of the quartz-crystal piece when the quartz-crystal resonator 20 is bonded to the wiring board 40.

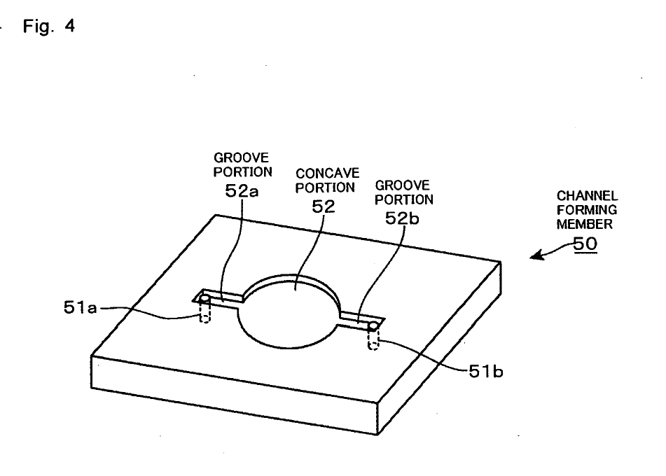

Next, the sensor unit 2 will be described by using FIG. 3 and FIG. 4. FIG. 3 shows an enlarged vertical section of the sensor unit 2. A rear surface side of the channel forming member 50 is shown in FIG. 4. The channel forming member 50 is formed in a shape corresponding to a shape of the one end side of the wiring board 40 by using an elastic material, for example, silicon rubber. At a center portion of the rear surface side of the channel forming member 50, a circular concave portion 52 is formed. In a state where the channel forming member 50 and the wiring board 40 are laid one on the other and the concave portion 52 is pressed against the quartz-crystal resonator 20, the concave portion serves as the reaction channel. Therefore, the concave portion and the reaction channel will be both denoted by reference number 52. The diameter of the concave portion 52 is set slightly larger than an area, of the quartz-crystal resonator 20, including the first oscillation area and the second oscillation area, and when the channel forming member 50 abuts on the wiring board 40, this area is located inside the concave portion 52. The height of the concave portion 52 is set to, for example, 0.2 mm or less, and in this example, is set to 0.1 mm.

A ceiling surface of the concave portion 52 is an opposed surface opposed to the oscillation areas on the front surface side being one surface side of the quartz-crystal resonator 20 via a gap, and in an area between the opposed surface and the quartz-crystal resonator 20, that is, in an area facing the oscillation areas of the quartz-crystal resonator 20, the reaction channel 52 is formed. The reaction channel 52 includes the opposed surface and an inner peripheral surface surrounding a periphery of an area above the oscillation areas.

In the channel forming member 50, groove portions 52a, 52b are formed so as to be opposed to each other in a diameter direction of the concave portion 52 via the concave portion 52 and so as to extend linearly from a circumferential edge of the concave portion 52 as shown in FIG. 4. Therefore, the groove portions 52a, 52b serve as channels surrounded by portions, of the quartz-crystal resonator 20, apart from the oscillation areas and by the channel forming member 50 and communicate with the concave portion, that is, the reaction channel 52. The groove portions and the channels will be both denoted by references 52a (52b). These channels 52a (52b) correspond to inner channels of the claims.

In a structure where the channel forming member 50 and a cover 70 are assembled, a channel 51a extending upward at a right angle from an end portion, of the inner channel 52a, opposite the reaction channel 52 and further extending obliquely upward is formed. The channel 51a corresponds to an outer channel on a supply side, and a liquid supply pipe 72 is connected to an upper end of the outer channel 51a. Further, in the aforesaid structure, a channel 51b extending upward at a right angle from an end portion, of the inner channel 52b, opposite the reaction channel 52 and further extending obliquely upward is formed. The channel 51b corresponds to an outer channel on a discharge side, and a liquid discharge pipe 73 is connected to an upper end of the outer channel 51b. The inner channel 52a and the outer channel 51a form a liquid supply channel, and the inner channel 52b and the outer channel 51b form a liquid discharge channel.

In a support 60, a concave portion 61 in which the wiring board 40 and the channel forming member 50 are fit and held is formed. Therefore, when the channel forming member 50 is pressed against the wiring board 40 in a state where the wiring board 40 is fit in the concave portion 61, the quartz-crystal resonator 20 is pressed against the wiring board 40 by a lower surface of the channel forming member 50 to be fixed. Further, the support 60 is covered by the cover 70 from above.

Further, as shown in FIG. 8, the sensing device 8 includes an oscillator circuit unit 30, a measurement circuit part 81, a data processing part 82, a sample solution supply part 83, a buffer solution supply part 84, a supplied liquid switching part 85, and a waste liquid reservoir part 86.

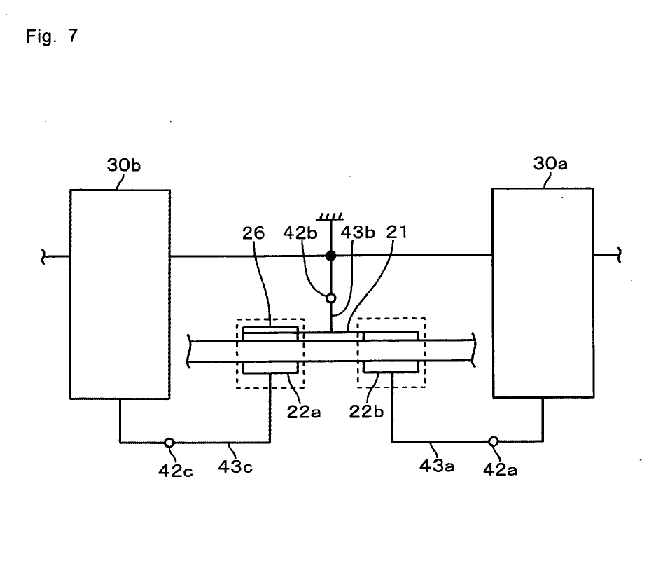

When the oscillator circuit unit 30 is inserted in the sensor unit 2, electrodes 42a, 42b, 42c being the connection terminal portions of the wiring board 40 are connected to oscillator circuits 30a, 30b. FIG. 7 is a circuit diagram showing the oscillator circuit unit 30 and the quartz-crystal resonator 20. As shown in FIG. 7, the first oscillation area corresponding to the excitation electrode 22b is connected to the oscillator circuit 30a and the second oscillation area corresponding to the excitation electrode 22a is connected to the oscillator circuit 30b.

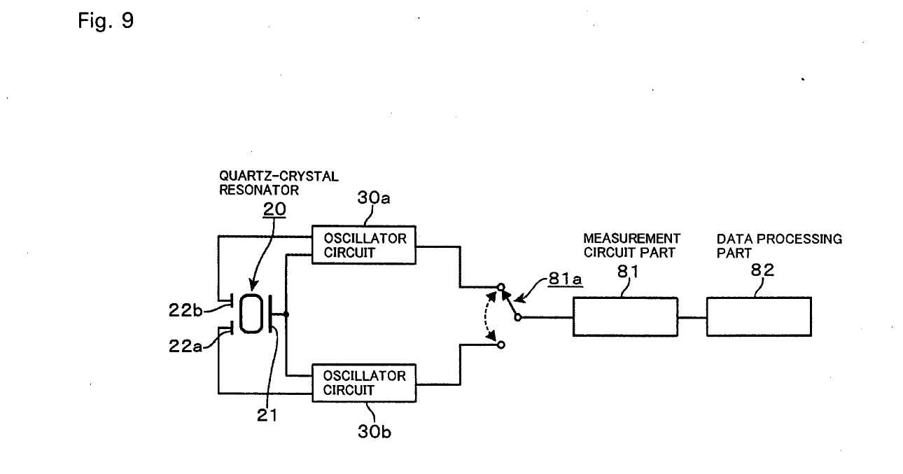

As shown in FIG. 8 and FIG. 9, on a subsequent stage of the oscillator circuit unit 30, the measurement circuit part 81 and the data processing part 82 are provided. The measurement circuit part 81 has a function of, for example, digitally processing frequency signals being input signals to measure oscillation frequencies. Incidentally, the measurement circuit part 81 may be a frequency counter, and its measuring method can be appropriately selected. Further, on a preceding stage of the measurement circuit part 81, a switch part 81a for taking output signals from the oscillator circuits 30a, 30b in a time-division manner is provided. The switch part 81a is capable of taking the frequency signals from the oscillator circuits 30a, 30b in a time-division manner. The data processing part 82 is a part storing time-series data of the measured frequencies and displaying the time-series data, and is constituted by a personal computer, for instance.

The sample solution supply part 83 and the buffer solution supply part 84 are connected to the supplied liquid switching part 85 via pipes 83a, 84a respectively. The supplied liquid switching part 85 is connected to the liquid supply pipe 72 and plays a role of switchably connecting one of the pipes 83a, 84a to the liquid supply pipe 72. The waste liquid reservoir part 86 is connected to the sensor unit 2 via the liquid discharge pipe 73. The switching of a liquid channel by the supplied liquid switching part 85 takes place, for example, according to a signal that is output based on a program in the data processing part 82, but may be manual-based.

Next, the operation of the sensing device 8 as structured above will be described. First, the sensor unit 2 is opened upward, for instance, the quartz-crystal sensor 3 is placed on the support 60, and the sensor unit 2 is closed so that the front surface of the quartz-crystal sensor 3 is pressed by the channel forming member 50, whereby the quartz-crystal sensor 3 is mounted in the sensor unit 2. Next, a buffer solution, for example, a phosphoric acid buffer is supplied into the sensor unit 2 from the buffer solution supply part 84 via the supplied liquid switching part 85. The flow of the buffer solution into the sensor unit 2 will be described. In the sensor unit 2, the buffer solution passes through the outer channel 51a extending obliquely and further extending vertically, reaches an upstream end of the inner channel 52a, and flows horizontally from the upstream end along the inner channel 52a to flow into the reaction channel 52. Further, the buffer solution flows in the reaction channel 52 toward an entrance of the inner channel 52b on the discharge side, and after flowing horizontally along the inner channel 52b, flows upward in the outer channel 51b, and is discharged to a not-shown discharge channel.

The first oscillation area and the second oscillation area of the quartz-crystal sensor 3 are oscillated by the oscillator circuits 30a, 30b respectively, and their oscillation frequencies are taken into the measurement circuit part 81 in a time-division manner by the switch part 81a performing the switching operation.

Then, after the frequencies of the frequency signals obtained by the measurement circuit part 81 are stabilized, the supplied liquid switching part 85 is switched automatically or manually, whereby a sample solution, for example, serum or blood already stored in a column 87 is pushed out by the buffer solution to similarly pass in the reaction channel 52. At this time, the antigen being the substance to be sensed in the sample solution is adsorbed by the adsorption layer 26 of the quartz-crystal sensor 3 according to its concentration. That is, due to the antigen-antibody reaction, the antigen is captured by the antibody, and consequently, the oscillation frequency of the second oscillation area of the quartz-crystal sensor 3 lowers. Consequently, the data processing part 82 obtains a decrement Δf1 of the frequency of the second oscillation area (a difference between the frequency when the sample solution is supplied and the frequency when the buffer solution is supplied). In the first oscillation area, on the other hand, since the adsorption layer 26 is not formed, there should occur no frequency change, but a disturbance such as a temperature change, if any, causes a change in the frequency. The data processing part 82 subtracts Δf1 from Δf2, which is the variation due to the disturbance, to cancel the variation in the frequency due to the disturbance, so that it is possible to obtain a variation in the frequency according to an amount of the antigen with high accuracy. The buffer solution is used as a comparison liquid before the sample solution is supplied to the reaction channel 52 as previously described, and is also used as a working liquid pushing out the sample solution in the column 87. However, the comparison liquid and the working liquid are not limited to the buffer solution but may be pure water or the like.

According to the above-described embodiment, since the distance from the front surface of the quartz-crystal resonator 20 to the opposed surface of the channel forming member 50, that is, the height of the reaction channel 52 is set to 0.2 mm or less, preferably 0.1 mm or less, a ratio of a volume of the sample solution coming into contact with or flowing near the adsorption layer 26 to the total volume of the supplied sample solution is increased. Therefore, an amount of the substance to be sensed adsorbed by the adsorption layer 26 increases and an amount of the substance to be sensed discharged without being adsorbed decreases. As a result, sensitivity and accuracy of the measurement by the sensing device improve.

Further, the liquid supplied into the sensor unit 2 flows in the outer channel 51a and the inner channel 52a on the supply side in this order, reaches the reaction channel 52, and is discharged to the outside after passing in the inner channel 52b and the outer channel 51b on the discharge side. Therefore, since a place where the liquid reaches the quartz-crystal piece 20a from an upper side (supply point) and a place where the liquid flows out from the quartz-crystal piece 20a to the upper side (discharge point) are far from the adsorption layer 26, an influence that a change in liquid pressure at the supply point and the discharge point has on liquid flow at a place where the adsorption layer 26 is formed can be reduced, which allows the reaction channel 26 to be formed with a small diameter. This enables the stable measurement of the substance to be sensed by the sensing device 8, resulting in high reliability.

Furthermore, the conductive path 43c extending from the lead-out position closer to the connection terminal of the quartz-crystal sensor 3, out of the lead-out positions of the two pairs of the electrodes (the first oscillation area and the second oscillation area) of the quartz-crystal piece 20a, is formed in a meandering shape, and thus has an equal length to that of the conductive path 43a extending from the lead-out position more distant from the connection terminal, thereby making the both conductive paths 43a, 43c equal in impedance. Consequently, the first oscillation area and the second oscillation area have substantially the same electric characteristic when seen from the oscillator circuit unit 30 as previously described, which contributes to improvement in measurement reliability.

Here, the present inventor has found out the following fact that backs up the superiority of a 0.1 mm height of the reaction channel 52 over a 1.0 mm height from a viewpoint of sensitivity and accuracy of the measurement.

Taking the reaction of physical adsorption of a 100 μg/ml anti-CRP as an example, a reaction amount in a quartz-crystal sensor whose reaction channel 52 has a 0.1 mm height is about 1.3 times a reaction amount in a quartz-crystal sensor whose reaction channel 52 has a 1.0 mm height, the former being 1850 Hz, while the latter being about 1400 Hz. For measuring the frequency of the quartz-crystal sensor, the sample solution in the column is pushed out by the buffer solution to be made to flow on the quartz-crystal sensor, and a difference between measured values of the frequencies when the buffer solution is flowing on the quartz-crystal sensor before and after the sample solution passes thereon corresponds to the reaction amount. Therefore, the quartz-crystal sensor whose reaction channel 52 has a 0.1 mm height can be said to be superior in measurement sensitivity. Here, CRP (C-reactive protein) is a protein appearing in blood when an inflammatory response or tissue breakage occurs in the body, and the C-reactive protein is involved in the cohesion of bacteria and has an action of activating a classical route of complements. The anti-CRP is a protein (antibody) that immunoreacts with CRP.

Further, when accuracy is compared between the type where the reaction channel 52 has a 1.0 mm height and the type where the reaction channel 52 has a 0.1 mm height in terms of standard deviations (S-D values) which are obtained when three quartz-crystal sensors prepared for each of the types perform the measurement three times, the standard deviation is 5.6 in the 0.1 mm type, while it is 40 in the 1.0 mm type, and improvement is recognized in the former.

Therefore, setting the height of the reaction channel 52 to 0.1 mm provides a remarkable effect, but it is thought that a 0.2 mm height can also provide this effect sufficiently compared with the 1.0 mm height. As for a lower limit of the height of the reaction channel 52, if the height is smaller than 0.1 mm, it takes a long time for the sample solution to flow therein, and therefore, provided that difficulty in manufacture can be overcome and the long-time measurement is not problematic, the height may be smaller than 0.1 mm, in other words, the lower limit of the height may be any except zero, but it is thought that the height of an actual sensing device is about 0.1 mm.

Further, in the above-described embodiment, the present invention is applied to what is called a twin sensor of a type in which the two electrode pairs (two pairs) are provided to form the two oscillation areas, but the effect of setting the height of the reaction channel 52 to 0.2 mm or less can be obtained also in what is called a single sensor in which one pair of electrodes are provided. Therefore, the present invention is also applicable to the single sensor.

What is claimed is:

1. A sensing device which uses a piezoelectric sensor having an adsorption layer formed on an electrode provided on a piezoelectric piece, and senses a substance to be sensed in a sample solution based on a change in a natural frequency of the piezoelectric piece caused by the adsorption of the substance to be sensed by the adsorption layer when the sample solution is supplied to the piezoelectric sensor in a flowing manner, the sensing device including:
a channel forming member including an opposed surface opposed to an oscillation area on one surface side of the piezoelectric sensor via a gap to form a reaction channel in an area facing the one surface side;
a liquid supply channel through which a liquid is supplied to the reaction channel and a liquid discharge channel through which a liquid is discharged from the reaction channel;
an oscillator circuit oscillating the piezoelectric piece; and
a frequency measuring part measuring an oscillation frequency of the oscillator circuit, wherein
a height of the reaction channel facing the oscillation area on the one surface side of the piezoelectric sensor is 0.2 mm or less.

2. The sensing device according to claim 1, wherein:
the reaction channel includes the opposed surface and an inner peripheral surface surrounding a periphery of an area above the oscillation area;
the liquid supply channel includes: an inner channel whose downstream end is opened in part of the inner peripheral surface and whose upstream end is located on a front surface of the piezoelectric piece outside the reaction channel; and an outer channel through which a liquid flows into the upstream end of the inner channel; and
the liquid discharge channel includes: an inner channel whose upstream end is opened in part of the inner peripheral surface and whose downstream end is located on the front surface of the piezoelectric piece outside the reaction channel; and an outer channel through which a liquid flows out from the downstream end of the inner channel.

3. The sensing device according to claim 1, wherein:
the piezoelectric sensor includes: the piezoelectric piece attached to one end side of a wiring board; a connection terminal provided on another end side of the wiring board to electrically connect the electrode of the piezoelectric piece to the oscillator circuit; and a conductive path provided on the wiring board to connect the electrode and the connection terminal;
on the piezoelectric piece, two pairs of the electrodes are formed at a spaced interval to respectively form a first oscillation area and a second oscillation area that oscillate independently of each other; and
in order for the conductive path provided for one pair of the electrodes out of two pairs of the electrodes to have an equal impedance to an impedance of the other conductive path provided for the other pair of the electrodes, the conductive path whose portion connected to the electrode is closer to the connection terminal, out of the both conductive paths, is in a meandering shape.
